(19) United States
(12) Patent Application Publication
(10) Pub. No.: US 2020/0361814 A1
(43) Pub. Date: Nov. 19, 2020

(54) SUBSTRATE WITH FILM

(71) Applicant: AGO Inc., Chiyoda-ku (JP)

(72) Inventors: Yusuke TOMIYORI, Chiyoda-ku (JP); Kiyotaka TAKAO, Chiyoda-ku (JP); Taiki HOSHINO, Chiyoda-ku (JP); Toyokazu ENTA, Chiyoda-ku (JP); Maemi Iwahashi, Chiyoda-ku (JP)

(73) Assignee: AGO Inc., Chiyoda-ku (JP)

(21) Appl. No.: 16/984,213

(22) Filed: Aug. 4, 2020

Related U.S. Application Data
(63) Continuation of application No. PCT/JP2019/010666, filed on Mar. 14, 2019.

(30) Foreign Application Priority Data
Mar. 16, 2018 (JP) 2018-050077
Sep. 27, 2018 (JP) 2018-181620

(51) Int. Cl. C03C 17/30; C09D 201/04; C09D 201/10

(52) U.S. Cl. CPC C03C 17/30; C09D 201/04; C03C 2217/40; C03C 2217/76; C09D 201/10

(57) ABSTRACT

To provide a substrate with a film excellent in fingerprint stain removability and sliding resistance.

The substrate with a film of the present invention comprises a substrate and a film having a poly(oxyfluoroalkylene) chain disposed only on a part of region on the principal plane of the substrate.

### TECHNICAL FIELD

The present invention relates to a substrate with a film.

### BACKGROUND ART

A fluorinated compound shows high lubricity, water/oil repellency, etc. and thus is used for a surface treatment agent. By imparting water/oil repellency to the surface of a substrate with a surface treatment agent, it becomes easy to wipe off stains from the surface of the substrate, whereby stain removability will be improved. Among fluorinated compounds, a fluorinated ether compound having a poly(oxyfluoroalkylene) chain wherein ether bonds (—O—) are present in the fluoroalkylene chain, is a compound excellent in flexibility and is particularly excellent in removability of stains of e.g. fats and oils.

As such a fluorinated ether compound, a compound having a poly(oxyperfluoroalkylene) chain and having a hydrolysable silyl group on its terminal has been widely used (Patent Document 1).

### PRIOR ART DOCUMENTS

### Patent Documents

Patent Document 1: WO2014/069592

### DISCLOSURE OF INVENTION

### Technical Problem

A surface treatment agent containing the fluorinated ether compound is used in an application where it is desired to maintain, for a long period of time, a performance (fingerprint stain removability) whereby a fingerprint adhering to the surface can be readily removed by wiping. Such an application may, for example, be a surface treatment agent for a member constituting a plane of e.g. a smartphone to be touched with e.g. hands or fingers (for example, a display screen or an opposite side from the display screen (rear side)).

The present inventors have evaluated a substrate with a film having a film obtained by using a fluorinated ether compound on the entire principal plane of the substrate, and found that although excellent fingerprint stain removability is obtained, the substrate is inferior in sliding resistance (that is, the substrate with a film tends to slide). For example, in a case where the substrate with a film is a smartphone, the smartphone may be dropped and broken when it is operated or placed on e.g. a desk.

Under these circumstances, the object of the present invention is to provide a substrate with a film excellent in fingerprint stain removability and sliding resistance.

### Solution to Problem

The present inventors have conducted extensive studies on the above object and as a result, found that desired effects can be obtained by disposing a film having a poly(oxyfluoroalkylene) chain only on a part of the principal plane of the substrate, and accomplished the present invention.

That is, the present inventors have found that the above object can be achieved by the following constitutions.
[1] A substrate with a film, comprising a substrate and a film having a poly(oxyfluoroalkylene) chain disposed only on a part of region on the principal plane of the substrate.
[2] The substrate with a film according to [1], wherein the film is a film formed by using a fluorinated ether compound having a poly(oxyfluoroalkylene) chain and a reactive silyl group.
[3] The substrate with a film according to [1] or [2], wherein the area ratio of a first region on which the film having a poly(oxyfluoroalkylene) chain is disposed to a second region on which the film having a poly(oxyfluoroalkylene) chain is not disposed (area of the first region/area of the second region) is from 0.3 to 50.0.
[4] The substrate with a film according to any one of [1] to [3], wherein the substrate is a substrate for a touch panel or a display substrate.
[5] The substrate with a film according to any one of [1] to [4], wherein the substrate is composed of glass, and the rate of the principal plane covered with the film having a poly(oxyfluoroalkylene) chain is from 20 to 97%.
[6] The substrate with a film according to any one of [1] to [5], wherein the film is disposed on a plurality of regions in dots.
[7] The substrate with a film according to [6], wherein the plurality of regions in dots are arranged in a checkered flag form.
[8] The substrate with a film according to any one of [1] to [5], wherein the film is disposed on a strip region on the principal plane of the substrate.
[9] The substrate with a film according to any one of [1] to [5], wherein the substrate has on its principal plane a peripheral region and a center region surrounded by the peripheral region, and the film is disposed on the center region.
[10] The substrate with a film according to any one of [1] to [5], wherein the substrate has on its principal plane a plurality of dotted dispersed regions and a continuous region other than the dispersed regions, and the film is disposed on the continuous region.

### Advantageous Effects of Invention

According to the present invention, a substrate with a film excellent in fingerprint stain removability and sliding resistance is provided.

### BRIEF DESCRIPTION OF DRAWINGS

FIG. 1 is a schematic plan view illustrating an example of a substrate with a film of the present invention.

FIG. 2 is a schematic oblique view illustrating an example of a substrate with a film of the present invention.

FIG. 3 is a schematic plan view illustrating an example of a substrate with a film of the present invention.

FIG. 4 is a schematic plan view illustrating an example of a substrate with a film of the present invention.

FIG. 5 is a schematic plan view illustrating an example of a substrate with a film of the present invention.

FIG. 6 is a schematic plan view illustrating an example of a substrate with a film of the present invention.

### DESCRIPTION OF EMBODIMENTS

In this specification, units represented by the formula (1) will be referred to as units (1). Units represented by other formulae will be referred to in the same manner. A group represented by the formula (2) will be referred to as group (2). Groups represented by other formulae will be referred to in the same manner. A compound represented by the formula (3) will be referred to as compound (3). Compounds represented by other formulae will be referred to in the same manner.

In this specification, a case where “an alkylene group may have group A” includes a case where the alkylene group has the group A between carbon atoms of the alkylene group or may have the group A at the terminal, that is, the alkylene group-the group A-.

Meanings of terms in the present invention are as follows.

“A bivalent organopolysiloxane residue” is a group represented by the following formula. In the following formula, R^{x} is an alkyl group (preferably C₁₋₁₀) or a phenyl group. g1 is an integer of at least 1, preferably an integer of from 1 to 9, particularly preferably an integer of from 1 to 4.

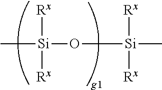

A “silphenylene group” is a group represented by —Si(R^{y})₂PhSi(R^{y})₂—, wherein Ph is a phenylene group, and R^{y} is a monovalent organic group. R^{y} is preferably an alkyl group (preferably C₁₋₁₀).

A “dialkylsilylene group” is a group represented by —Si(R^{z})₂—, wherein R^{z} is an alkyl group (preferably C₁₋₁₀)).

The “number average molecular weight” of a compound is calculated by obtaining the number (average value) of oxyfluoroalkylene groups based on terminal groups by ¹H-NMR and ¹⁹F-NMR.

The substrate with a film of the present invention (hereinafter sometimes referred to as “the present substrate with a film” comprises a substrate and a film having a poly(oxyfluoroalkylene) chain (hereinafter sometimes referred to as a “first film”) disposed only on a part of region on the principal plane of the substrate.

In the following description, of the substrate, a surface having the first film disposed thereon, which is a main surface and which may be touched by other article or by human hands or fingers, and/or which may be handled by human hands or fingers at the time of operation, will be referred to as a “principal plane”. The principle plane is not limited to planar.

On the principal plane of the substrate, a region on which the first film is disposed will be referred to as a “first region”, and a region on which the first film is not disposed will be referred to as a “second region”.

The substrate with a film having a poly(oxyfluoroalkylene) chain on the principal plane, as compared with a surface composed of other material (such as glass), has excellent fingerprint stain removability, but tends to have a low dynamic friction coefficient. Accordingly, it is estimated that by disposing the film having a poly(oxyfluoroalkylene) chain only on a part of region on the principal plane of the substrate, while excellent fingerprint stain removability is maintained, excellent sliding resistance can be secured.

The substrate is preferably a substrate which may be used as touched with other article (such as a stylus) or human hands or fingers, a substrate which may be held by human hands or fingers at the time of operation, and/or a substrate which may be placed on other article (such as a holder). Since water/oil repellency can be imparted, a substrate which is required to have water/oil repellency is particularly preferred. As specific examples of a material of the substrate, a metal, a resin, glass, sapphire, a ceramic, stone or a hydrophilic film, or a composite material thereof, may be mentioned. The glass may be chemically tempered.

The substrate is preferably a substrate for a touch panel or a display substrate, particularly preferably a substrate for a touch panel. The substrate for a touch panel preferably has transparency to light. “Having transparency to light” means a normal-incidence visible light transmittance in accordance with JIS R3106:1998 (ISO 9050:1990) of at least 25%. As the material of the substrate for a touch panel, glass or a transparent resin is preferred.

Further, as the substrate, the following examples may be mentioned. Glass and a resin to be used for a building material, a decorative building material, an interior article, a transport (such as an automobile), an advertising display/bulletin board, a beverage container/tableware, an aquarium, an ornamental instrument (such as a frame or a box), a laboratory instrument, furniture, and art/sports/games, and glass and a resin to be used for an exterior member (excluding a display part) of an apparatus such as a mobile phone (for example a smartphone), a personal digital assistant, a gaming machine or a remote controller are preferred. The substrate may be in a plate form or in a film form.

### [First Film]

The first film is a film having a poly(oxyfluoroalkylene) chain and is disposed only on a part of region on the principal plane of the substrate.

The first film may be formed directly on the principal plane of the substrate or may be formed on the substrate via other film formed on the principal plane of the substrate. As specific examples of other film, a primary film formed on the principal plane of a substrate obtained by subjecting the substrate to primary coat treatment with e.g. compounds described in WO2011/016458, paragraphs 0089 to 0095 or SiO₂, may be mentioned.

The poly(oxyfluoroalkylene) chain contains a plurality of units represented by the following formula (1):

(OX) (1)

X is a fluoroalkylene group having at least one fluorine atom.

The number of carbon atoms in the fluoroalkylene group is preferably from 1 to 6, particularly preferably from 2 to 4, in view of more excellent weather resistance and corrosion resistance of the film.

The fluoroalkylene group may be linear or branched, and is preferably linear in view of more excellent effects of the present invention.

The fluoroalkylene group has at least one fluorine atom, and in view of more excellent corrosion resistance of the film, preferably from 2 to 10, particularly preferably from 2 to 4.

The fluoroalkylene group may be a group having all hydrogen atoms in the fluoroalkylene group substituted by fluorine atoms (perfluoroalkylene group).

As specific examples of the units (1), —OCHF—, —OCF₂CHF—, —OCHFCF₂—, —OCF₂CH₂—, —OCH₂CF₂—, —OCF₂CF₂CHF—, —OCHFCF₂CF₂—, —OCF₂CF₂CH₂—, —OCH₂CF₂CF₂—, —OCF₂CF₂CF₂CH₂—, —OCH₂CF₂CF₂CF₂—, —OCF₂CF₂CF₂CF₂CH₂—, —OCH₂CF₂CF₂CF₂CF₂—, —OCF₂CF₂CF₂CF₂CF₂CH₂—, —OCH₂CF₂CF₂CF₂CF₂CF₂—, —OCF₂—, —OCF₂CF₂—, —OCF₂CF₂CF₂—, —OCF(CF₃)CF₂—, —OCF₂CF₂CF₂CF₂—, —OCF(CF₃)CF₂CF₂—, —OCF₂CF₂CF₂CF₂CF₂— and —OCF₂CF₂CF₂CF₂CF₂CF₂— may be mentioned.

The number ml of units (1) contained in the poly(oxyfluoroalkylene) chain is at least 2, preferably an integer of from 2 to 200, more preferably an integer of from 5 to 150, particularly preferably an integer of from 5 to 100, most preferably an integer of from 10 to 50.

The poly(oxyfluoroalkylene) chain may contain only one type of the units (1) or two or more types of the units (1). The two or more type of the units (1) may, for example, be two or more types of the units (1) differing in the number of carbon atoms, two or more types of the units (1) differing in whether side chains are present or not or in the type of side chains even having the same number of carbon atoms, or two or more types of the units (1) differing in the number of fluorine atoms even having the same number of carbon atoms.

The bonding order of the two or more types of (OX) is not limited, and the units may be arranged randomly, alternately or in block.

In order to obtain a film excellent in fingerprint stain removability, the poly(oxyfluoroalkylene) chain is preferably a poly(oxyfluoroalkylene) chain composed mainly of oxyperfluoroalkylene groups as the units (1). In the poly(oxyfluoroalkylene) chain represented by (OX)ₘ₁, the ratio of the number of the units (1) being an oxyperfluoroalkylene group to the total number ml of the units (1) is preferably from 50 to 100%, more preferably from 80 to 100%, particularly preferably from 90 to 100%.

(OX)ₘ₁ is preferably [(OCHₘₐF₍₂₋ₘₐ₎)ₘ₁₁.(OC₂H_{mb}F_{(4-mb)})ₘ₁₂.(OC₃H_{mc}F_{(6mc)})ₘ₁₃.(OC₄H_{md}F_{(8-md)})ₘ₁₄.(OC₅HₘₑF₍₁₀₋ₘₑ₎)ₘ₁₅.(OC₆H_{mf}F_{(12-mf)})ₘ₁₆].

ma is 0 or 1, mb is an integer of from 0 to 3, mc is an integer of from 0 to 5, and is an integer of from 0 to 7, me is an integer of from 0 to 9, and mf is an integer of from 0 to 11.

m11, m12, m13, m14, m15 and m16 are each independently an integer of at least 0 and preferably at most 100.

m11+m12+m13+m14+m15+m16 is an integer of at least 2, more preferably an integer of from 2 to 200, more preferably an integer of from 5 to 150, further preferably an integer of from 5 to 100, particularly preferably an integer of from 10 to 50.

Particularly, m12 is preferably an integer of at least 2, particularly preferably an integer of from 2 to 200.

Further, each of C₃H_{mb}F_{(6-mb)}, C₄H_{mc}F_{(8-mc)}, C₅H_{md}F_{(10-md)} and C₆HₘₑF₍₁₂₋ₘₑ₎ may be linear or branched and is preferably linear in view of more excellent abrasion resistance of the film.

The above formula represents the type and the number of the units, not the arrangement of the units. That is, m11 to m15 represent the number of the units and for example, (OCHₘₐF₍₂₋ₘₐ₎)ₘ₁₁ does not represent a block having m11 continuous (OCHₘₐF₍₂₋ₘₐ₎) units. Likewise, the order of description of (OCHₘₐF₍₂₋ₘₐ₎) to (OC₆H_{mf}F_{(12-mf)}) does not represent that the respective units are arranged in the order of description.

In the above formula, when at least two of m11 to m15 are not 0 (that is, (OX)ₘ₁ is constituted by two or more types of units), the arrangement of the different units may be any of random arrangement, alternate arrangement, block arrangement and a combination thereof.

Further, with respect to other units, in a case where two or more units are contained, these units may be different. For example, in a case where m11 is at least 2, a plurality of (OCHₘₐF₍₂₋ₘₐ₎) may be the same of different.

The first film is preferably a film obtained by using a fluorinated ether compound having a poly(oxyfluoroalkylene) chain and a reactive silyl group. The reactive silyl group means a hydrolysable silyl group or a silanol group (Si—OH). The reactive silyl group is preferably a group (2) represented by the following formula (2). The fluorinated ether compound may be used alone or in combination of two or more.

The definition of the poly(oxyfluoroalkylene) chain is as defined above.

—Si(R)ₙL₃₋ₙ (2)

The number of the group (2) in the fluorinated ether compound is at least 1, and in view of more excellent abrasion resistance of the film, at least 2, more preferably from 2 to 10, further preferably from 2 to 5, particularly preferably 2 or 3.

In a case where there are two or more groups (2) in one molecule, the two or more groups (2) may be the same or different. In view of availability of the raw materials and production efficiency of the fluorinated ether compound, they are preferably the same.

R is a monovalent hydrocarbon group and is preferably a monovalent saturated hydrocarbon group. The number of carbon atoms in R is preferably from 1 to 6, more preferably from 1 to 3, particularly preferably from 1 to 2.

L is a hydrolysable group or a hydroxy group.

The hydrolysable group is a group to be a hydroxy group by hydrolysis. That is, a silyl group having hydrolysability becomes a silanol group represented by Si—OH by hydrolysis. The silanol group further forms a Si—O—Si bond by reaction between silanol groups. Further, the silanol group may form a chemical bond (substrate-O—Si) by dehydration condensation with the hydroxy group (substrate-OH) on the surface of the substrate.

Specific examples of L as the hydrolysable group, an alkoxy group, a halogen atom, an acyl group and an isocyanate group (—NCO) may be mentioned. The alkoxy group is preferably a C₁₋₄ alkoxy group. The halogen atom is preferably a chlorine atom.

L is, with a view to more easily producing the fluorinated ether compound, a C₁₋₄ alkoxy group or a halogen atom is preferred. L is, in view of less outgassing at the time of coating and more excellent storage stability of the fluorinated ether compound, preferably a C₁₋₄ alkoxy group, and in a case where storage stability of the fluorinated ether compound for a long time is required, particularly preferably an ethoxy group, and in a case where the reaction time after coating should be short, particularly preferably a methoxy group.

n is an integer of from 0 to 2.

n is preferably 0 or 1, particularly preferably 0. When a plurality of L are present, adhesion of the film to the substrate will be more firm.

When n is 1 or less, the plurality of L present in one molecule may be the same or different. In view of availability of raw materials and production efficiency of the fluorinated ether compound, they are preferably the same. When n is 2, the plurality of R present in one molecule may be the same or different. In view of availability of raw materials and production efficiency of the fluorinated ether compound, the plurality of R are preferably the same.

The fluorinated ether compound is preferably a compound (3) represented by the following formula (3) in view of water/oil repellency and abrasion resistance of the film.

[A-(OX)ₘ₁—]ⱼZ[—Si(R)ₙL₃₋ₙ]_{g} (3)

A is a perfluoroalkyl group or -Q[-Si(R)ₙL₃₋ₙ]ₖ.

The number of carbon atoms in the perfluoroalkyl group is, in view of more excellent abrasion resistance of the film, preferably from 1 to 20, more preferably from 1 to 10, further preferably from 1 to 6, particularly preferably from 1 to 3.

The perfluoroalkyl group may be linear or branched.

When A is -Q[-Si(R)ₙL₃₋ₙ]ₖ, j is 1.

The perfluoroalkyl group may, for example, be CF₃—, CF₃CF₂—, CF₃CF₂CF₂—, CF₃CF₂CF₂CF₂—, CF₃CF₂CF₂CF₂CF₂—, CF₃CF₂CF₂CF₂CF₂CF₂— or CF₃CF(CF₃)—.

The perfluoroalkyl group is, in view of more excellent water/oil repellency of the film, preferably CF₃—, CF₃CF₂— or CF₃CF₂CF₂—.

Q is a (k+1) valent linking group. As described hereinafter, k is an integer of from 1 to 10. Accordingly, Q may be a bivalent to undecavalent linking group.

Q may be any group so long as it does not impar the effects of the present invention and may, for example, be an alkylene group which may have an etheric oxygen atom or a bivalent organopolysiloxane residue, a carbon atom, a nitrogen atom, a silicon atom, a bivalent to octavalent organopolysiloxane residue, or a group having Si(R)ₙL₃₋ₙ removed from any one of the following formulae (3-1A), (3-1B), (3-1A-1) to (3-1A-6).

R, L, n, X and m1 are as defined above.

Z is a (j+g) valent linking group.

Z may be any group so long as it does not impar the effects of the present invention and may, for example, be an alkylene group which may have an etheric oxygen atom or a bivalent organopolysiloxane residue, a carbon atom, a nitrogen atom, a silicon atom, a bivalent to octavalent organopolysiloxane residue, or a group having Si(R)ₙL₃₋ₙ removed from any one of the following formulae (3-1A), (3-1B), (3-1A-1) to (3-1A-6) described hereinafter.

j is an integer of at least 1, and in view of more excellent water/oil repellency of the film, preferably an integer of from 1 to 5, and in view of easy production of the compound (3), particularly preferably 1.

g is an integer of at least 1, and in view of more excellent abrasion resistance of the film, preferably an integer of from 2 to 4, more preferably 2 or 3, particularly preferably 3.

The compound (3) is, in view of more excellent water/oil repellency of the film, preferably a compound represented by the following formula (3-1):

A-(OX)ₘ₁—Z³¹ (3-1)

wherein A, X and m1 are as defined for the groups in the formula (3).

Z³¹ is a group (3-1A) represented by the following formula (3-1A) or a group (3-1B) represented by the following formula (3-1B).

-Q^{a}-X³¹(-Q^{b}-Si(R)ₙL₃₋ₙ)ₕ(-R³¹)ᵢ (3-1A)

-Q^{c}-[CH₂C(R³²)(-Q^{d}-Si(R)ₙL₃₋ₙ)]_{y}-R³³ (3-1B)

Q^{a} is a single bond or a bivalent linking group.

The bivalent linking group may, for example, be a bivalent hydrocarbon group, a bivalent heterocyclic group, —O—, —S—, —SO₂—, —N(R^{d})—, —C(O)—, —Si(R^{a})₂—, or a group having at least two types of such groups combined. R^{a} is an alkyl group (preferably C₁₋₁₀) or a phenyl group. R^{d} is a hydrogen atom or an alkyl group (preferably C₁₋₁₀).

The bivalent hydrocarbon group may be a bivalent saturated hydrocarbon group, a bivalent aromatic hydrocarbon group, an alkenylene group or an alkynylene group. The bivalent saturated hydrocarbon group may be linear, branched or cyclic, and may, for example, be an alkylene group. The number of carbon atoms in the bivalent saturated hydrocarbon group is preferably from 1 to 20. Further, the number of carbon atoms in the bivalent aromatic hydrocarbon group is preferably from 5 to 20, and the bivalent aromatic hydrocarbon group may, for example, be a phenylene group. The alkenylene group is preferably a C₂₋₂₀ alkenylene group, and the alkynylene group is preferably a C₂₋₂₀ alkynylene group.

The group having at least two types of such groups combined may, for example, be —OC(O)—, —C(O)N(R^{d})—, an alkylene group-O-alkylene group, an alkylene group-OC(O)-alkylene group, or an alkylene group-Si(R^{a})₂-phenylene group-Si(R^{a})₂.

X³¹ is a single bond, an alkylene group, a carbon atom, a nitrogen atom, a silicon atom or a bivalent to octavalent organopolysiloxane residue.

The alkylene group may have —O—, a silphenylene group, a bivalent organopolysiloxane residue or a dialkylsilylene group. The alkylene group may have a plurality of groups selected from the group consisting of —O—, a silphenylene group, a bivalent organopolysiloxane residue and a dialkylsilylene group.

The number of carbon atoms in the alkylene group represented by X³¹ is preferably from 1 to 20, particularly preferably from 1 to 10.

The bivalent to octavalent organopolysiloxane residue may be a bivalent organopolysiloxane residue or a (w+1) valent organopolysiloxane residue described hereinafter.

Q^{b} is a single bond or a bivalent linking group.

The bivalent linking group is as defined for the above Q^{a}.

R³¹ is a hydroxy group or an alkyl group.

The number of carbon atoms in the alkyl group is preferably from 1 to 5, more preferably from 1 to 3, particularly preferably 1.

When X³¹ is a single bond or an alkylene group, h is 1 and i is 0,

when X³¹ is a nitrogen atom, h is an integer of from 1 to 3, i is an integer of from 1 to 2, and h+i=2 is satisfied,

when X³¹ is a carbon atom or a silicon atom, h is an integer of from 1 to 3, i is an integer of from 0 to 2, and h+i=3 is satisfied, and

when X³¹ is a bivalent to octavalent organopolysiloxane residue, h is an integer of from 1 to 7, i is an integer of from 0 to 6, and h+i=1 to 7 is satisfied.

when h is at least 2, the two or more (-Q^{b}-Si(R)ₙL₃₋ₙ) may be the same or different. In a case where i is at least 2, the two (—R³¹) may be the same or different.

Q^{c} is a single bond, an alkylene group, or an alkylene group having at least 2 carbon atoms and having an etheric oxygen atom between carbon atoms, and in view of easy production of the compound, preferably a single bond.

The number of carbon atoms in the alkylene group is preferably from 1 to 10, particularly preferably from 2 to 6.

The number of carbon atoms in the alkylene group having at least 2 carbon atoms and having an etheric oxygen atom between carbon atoms is preferably from 2 to 10, particularly preferably from 2 to 6.

R³² is a hydrogen atom or a C₁₋₁₀ alkyl group, and in view of easy production of the compound, preferably a hydrogen atom.

The alkyl group is preferably a methyl group.

Q^{d} is a single bond or an alkylene group. The number of carbon atoms in the alkylene group is preferably from 1 to 10, particularly preferably from 1 to 6. In view of easy production of the compound, Q^{d} is preferably a single bond or —CH₂—.

R³³ is a hydrogen atom or a halogen atom, and in view of easy production of the compound, preferably a hydrogen atom.

y is an integer of from 1 to 10, preferably an integer of from 1 to 6.

The two or more [CH₂C(R³²)(-Q^{d}-Si(R)ₙL₃₋ₙ)] may be the same or different.

The group (3-1A) is preferably any one of groups (3-1A-1) to (3-1A-6).

—(X³²)ₛ₁-Q^{b1}-SiRₙL₃₋ₙ (3-1A-1)

—(X³³)ₛ₂-Q^{a2}-N[-Q^{b2}-Si(R)ₙ₃L₃₋ₙ]₂ (3-1A-2)

-Q^{a3}-G(R^{g})[-Q^{b3}-Si(R)ₙL₃₋ₙ]₂ (3-1A-3)

—[C(O)N(R^{d})]ₛ₄-Q^{a4}-(O)ₜ₄—C[—(O)ᵤ₄-Q^{b4}-Si(R)ₙL₃₋ₙ]_{w} (3-1A-4)

-Q^{a5}-Si[-Q^{b5}-Si(R)ₙL₃₋ₙ]₃ (3-1A-5)

—[C(O)N(R^{d})]ᵥ-Q^{a6}-Z^{a}[-Q^{b6}-Si(R)ₙL₃₋ₙ]_{w} (3-1A-6)

In the formulae (3-1A-1) to (3-1A-6), R, L and n are as defined above.

In the formula (3-1A-1), X³² is —O— or —C(O)N(R^{d})—, wherein N is bonded to Q^{b1}.

R^{d} is as defined above.

s1 is 0 or 1.

Q^{b1} is an alkylene group. The alkylene group may have —O—, a silphenylene group, a bivalent organopolysiloxane residue or a dialkylsilylene group. The alkylene group may have a plurality of groups selected from the group consisting of —O—, a silphenylene group, a bivalent organopolysiloxane residue and a dialkylsilylene group.

In a case where the alkylene group has —O—, a silphenylene group, a bivalent organopolysiloxane residue or a dialkylsilylene group, it preferably has such a group between carbon atoms.

The number of carbon atoms in the alkylene group represented by Q^{b1} is preferably from 1 to 10, particularly preferably from 2 to 6.

Q^{b1} is, when s1 is 0, preferably —CH₂OCH₂CH₂CH₂—, —CH₂OCH₂CH₂OCH₂CH₂CH₂—, —CH₂CH₂—, —CH₂CH₂CH₂—, or —CH₂OCH₂CH₂CH₂Si(CH₃)₂OSi(CH₃)₂CH₂CH₂—. When (X³²)ₛ₁ is —O—, it is preferably —CH₂CH₂CH₂— or —CH₂CH₂OCH₂CH₂CH₂—. When (X³²)ₛ₁ is —C(O)N(R^{d})—, it is preferably a C₂₋₆ alkylene group (provided that N in the formula is bonded to Q^{b1}). When Q^{b1} is such a group, the compound is easily produced.

As specific examples of the group (3-1A-1), the following groups may be mentioned. In the following formulae, * represents the bonding position to (OX)ₘ₁.

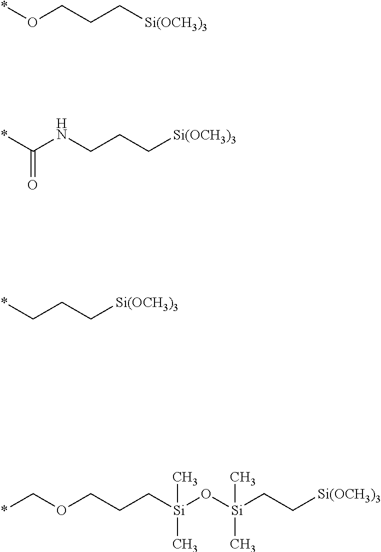

In the formula (3-1A-2), X³³ is —O—, —NH— or —C(O)N(R^{d})—.

R^{d} is as defined above.

Q^{a2} is a single bond, an alkylene group, —C(O)— or an alkylene group having at least 2 carbon atoms and having an etheric oxygen atom, —C(O)—, —C(O)O—, —OC(O)— or —NH— between carbon atoms.

The number of carbon atoms in the alkylene group represented by Q^{a2} is preferably from 1 to 10, particularly preferably from 1 to 6.

The number of carbon atoms in the alkylene group having at least 2 carbon atoms and having an etheric oxygen atom, —C(O)—, —C(O)O—, —OC(O)— or —NH— between carbon atoms, represented by Q^{a2}, is preferably from 2 to 10, particularly preferably from 2 to 6.

Q^{a2} is, in view of easy production of the compound, preferably —CH₂—, —CH₂CH₂—, —CH₂CH₂CH₂—, —CH₂OCH₂CH₂—, —CH₂NHCH₂CH₂—, —CH₂CH₂OC(O)CH₂CH₂— or —C(O)— (provided that the right side is bonded to N).

s2 is 0 or 1 (0 when Q^{a2} is a single bond). In view of easy production of the compound, it is preferably 0.

Q^{b2} is an alkylene group, or an alkylene group having at least 2 carbon atoms and having a bivalent organopolysiloxane residue, an etheric oxygen atom or —NH— between carbon atoms.

The number of carbon atoms in the alkylene group represented by Q^{b2} is preferably from 1 to 10, particularly preferably from 2 to 6.

The number of carbon atoms in the alkylene group having at least 2 carbon atoms and having a bivalent organopolysiloxane residue, an etheric oxygen atom or —NH— between carbon atoms, represented by Q^{b2}, is preferably from 2 to 10, particularly preferably from 2 to 6.

Q^{b2} is, in view of easy production of the compound, preferably —CH₂CH₂CH₂— or —CH₂CH₂OCH₂CH₂CH₂— (provided that the right side is bonded to Si).

The two [-Q^{b2}-Si(R)ₙL₃₋ₙ] may be the same or different.

As specific examples of the group (3-1A-2), the following groups may be mentioned. In the following groups, * represents the bonding position to (OX)ₘ₁.

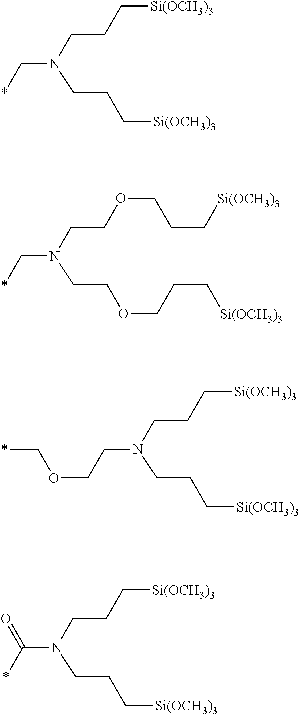

In the formula (3-1A-3), Q^{a3} is a single bond, an alkylene group, or an alkylene group having at least 2 carbon atoms and having an etheric oxygen atom between carbon atoms, and in view of easy production of the compound, it is preferably a single bond.

The number of carbon atoms in the alkylene group represented by Q^{a3} is preferably from 1 to 10, particularly preferably from 2 to 6.

The number of carbon atoms in the alkylene group having at least 2 carbon atoms and having an etheric oxygen atom between carbon atoms represented by Q^{a3} is preferably from 2 to 10, particularly preferably from 2 to 6.

G is a carbon atom or a silicon atom.

R^{g} is a hydroxy group or an alkyl group. The number of carbon atoms in the alkyl group represented by R^{g} is from 1 to 4.

G(R^{g}) is, in view of easy production of the compound, preferably C(OH) or Si(R^{ga}) (wherein R^{ga} is an alkyl group, the carbon number in the alkyl group is preferably from 1 to 10, and R^{ga} is particularly preferably a methyl group).

Q^{b3} is an alkylene group, or an alkylene group having at least 2 carbon atoms and having an etheric oxygen atom or a bivalent organopolysiloxane residue between carbon atoms.

The number of carbon atoms in the alkylene group represented by Q^{b3} is preferably from 1 to 10, particularly preferably from 2 to 6.

The number of carbon atoms in the alkylene group having at least 2 carbon atoms and having an etheric oxygen atom or a bivalent organopolysiloxane residue between carbon atoms represented by Q^{b3} is preferably from 2 to 10, particularly preferably from 2 to 6.

Q^{b3} is, in view of easy production of the compound, preferably —CH₂CH₂—, —CH₂CH₂CH₂— or —CH₂CH₂CH₂CH₂CH₂CH₂CH₂CH₂—.

The two [-Q^{b3}-Si(R)ₙL₃₋ₙ] may be the same or different.

As specific examples of the group (3-1A-3), the following groups may be mentioned. In the following formulae, * represents the bonding position to (OX)ₘ₁.

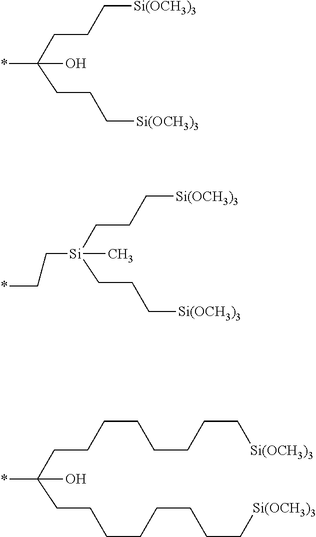

In the formula (3-1A-4), R^{d} is as defied above.

s4 is 0 or 1.

Q^{a4} is a single bond, an alkylene group, or an alkylene group having at least 2 carbon atoms and having an etheric oxygen atom between carbon atoms.

The number of carbon atoms in the alkylene group represented by Q^{a4} is preferably from 1 to 10, particularly preferably from 1 to 6.

The number of carbon atoms in the alkylene group having at least 2 carbon atoms and having an etheric oxygen atom between carbon atoms represented by Q^{a4} is preferably from 2 to 10, particularly preferably from 2 to 6.

t4 is 0 or 1 (0 when Q^{a4} is a single bond).

-Q^{a4}-(O)ₜ₄— is, in view of easy production of the compound, when s4 is 0, preferably a single bond, —CH₂O—, —CH₂OCH₂—, —CH₂OCH₂CH₂O—, —CH₂OCH₂CH₂OCH₂— or —CH₂OCH₂CH₂CH₂CH₂OCH₂— (provided that the left side is bonded to (R^{f}O)ₘ), and when s4 is 1, preferably a single bond, —CH₂— or —CH₂CH₂—.

Q^{b4} is an alkylene group, and the alkylene group may have —O—, —C(O)N(R^{d})— (wherein R^{d} is as defined above), a silphenylene group, a bivalent organopolysiloxane residue or a dialkylsilylene group.

When the alkylene group has —O— or a silphenylene group, it preferably has —O— or the silphenylene group between carbon atoms. Further, when the alkylene group has —C(O)N(R^{d})—, a dialkylsilylene group or a bivalent organopolysiloxane residue, it preferably has such a group between carbon atoms or at the terminal on the side bonded to (O)ᵤ₄.

The number of carbon atoms in the alkylene group represented by Q^{b4} is preferably from 2 to 10, particularly preferably from 2 to 6.

u4 is 0 or 1.

—(O)ᵤ₄-Q^{b4}- is, in view of easy production of the compound, preferably —CH₂CH₂—, —CH₂CH₂CH₂—, —CH₂OCH₂CH₂CH₂—, —CH₂OCH₂CH₂CH₂CH₂CH₂—, —OCH₂CH₂CH₂—, —OSi(CH₃)₂CH₂CH₂CH₂—, —OSi(CH₃)₂OSi(CH₃)₂CH₂CH₂CH₂— or —CH₂CH₂CH₂Si(CH₃)₂PhSi(CH₃)₂CH₂CH₂— (provided that the right side is bonded to Si).

The three [—(O)ᵤ₄-Q^{b4}-Si(R)ₙL₃₋ₙ] may be the same or different.

As specific examples of the (3-1A-4), the following groups may be mentioned. In the following formulae, * represents the bonding position to (OX)ₘ₁.

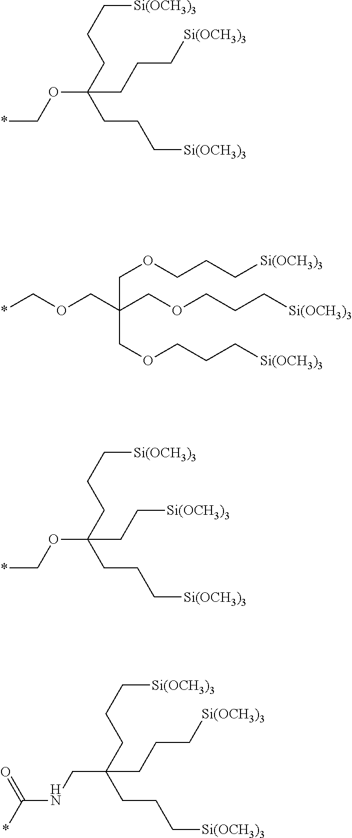

In the formula (3-1A-5), Q^{a5} is an alkylene group, or an alkylene group having at least 2 carbon atoms and having an etheric oxygen atom between carbon atoms.

The number of carbon atoms in the alkylene group represented by Q^{a5} is preferably from 2 to 10, particularly preferably from 2 to 6.

The number of carbon atoms in the alkylene group having at least 2 carbon atoms and having an etheric oxygen atom between carbon atoms represented by Q^{a5} is preferably from 2 to 10, particularly preferably from 2 to 6.

Q^{a5} is, in view of easy production of the compound, preferably —CH₂OCH₂CH₂CH₂—, —CH₂OCH₂CH₂OCH₂CH₂CH₂—, —CH₂CH₂— or —CH₂CH₂CH₂— (provided that the right side is bonded to Si).

Q^{b5} is an alkylene group, or an alkylene group having at least 2 carbon atoms and having an etheric oxygen atom or a bivalent organopolysiloxane residue between carbon atoms.

The number of carbon atoms in the alkylene group represented by Q^{b5} is preferably from 1 to 10, particularly preferably from 2 to 6.

The number of carbon atoms in the alkylene group having at least 2 carbon atoms and having an etheric oxygen atom or a bivalent organopolysiloxane residue between carbon atoms, represented by Q^{b5}, is preferably from 2 to 10, particularly preferably from 2 to 6.

Q^{b5} is, in view of easy production of the compound, preferably —CH₂CH₂CH₂— or —CH₂CH₂OCH₂CH₂CH₂— (provided that the right side is bonded to Si(R)ₙL₃₋ₙ).

The three [-Q^{b5}-Si(R)ₙL₃₋ₙ] may be the same or different.

As specific examples of the group (3-1A-5), the following groups may be mentioned. In the following formulae, * represents the bonding position to (OX)ₘ₁.

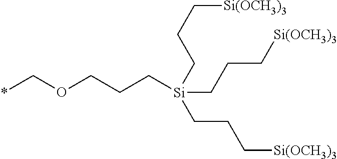

In the formula (3-1A-6), R^{d} is as defined above.

v is 0 or 1.

Q^{a6} is an alkylene group, or an alkylene group having at least 2 carbon atoms and having an etheric oxygen atom between carbon atoms.

The number of carbon atoms in the alkylene group represented by Q^{a6} is preferably from 1 to 10, particularly preferably from 2 to 6.

The number of the carbon atoms in the alkylene group having at least 2 carbon atoms and having an etheric oxygen atom between carbon atoms, represented by Q^{a6}, is preferably from 2 to 10, particularly preferably from 2 to 6.

Q^{a6} is, in view of easy production of the compound, preferably —CH₂OCH₂CH₂CH₂—, —CH₂OCH₂CH₂OCH₂CH₂CH₂—, —CH₂CH₂— or —CH₂CH₂CH₂— (provided that the right side is bonded to Z^{a}).

Z^{a} is a (w+1) valent organopolysiloxane residue.

w is an integer of from 2 to 7.

As the (w+1) valent organopolysiloxane residue, the following groups may be mentioned. In the following formulae, R^{a} is as defined above.

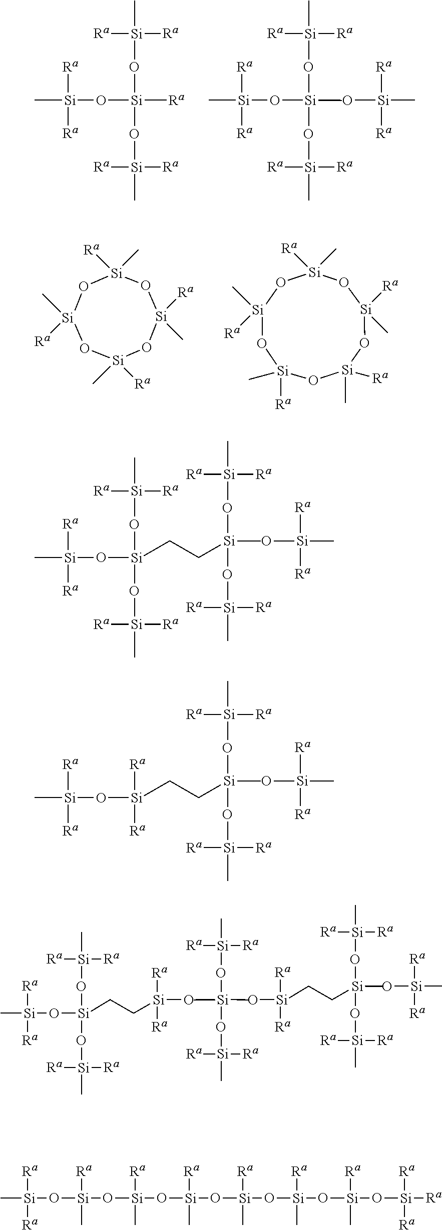

Q^{b6} is an alkylene group, or an alkylene group having at least 2 carbon atoms and having an etheric oxygen atom or a bivalent organopolysiloxane residue between carbon atoms.

The number of carbon atoms in the alkylene group represented by Q^{b6} is preferably from 1 to 10, particularly preferably from 2 to 6.

The number of carbon atoms in the alkylene group having at least 2 carbon atoms and having an etheric oxygen atom or a bivalent organopolysiloxane residue between carbon atoms, represented by Q^{b6}, is preferably from 2 to 10, particularly preferably from 2 to 6.

Q^{b6} is, in view of easy production of the compound, preferably —CH₂CH₂— or —CH₂CH₂CH₂—.

The w [-Q^{b6}-Si(R)ₙ₃L₃₋ₙ] may be the same or different.

The compound 3 is, in view of more excellent water/oil repellency of the film, preferably a compound represented by the formula (3-2).

[A-(OX)ₘ₁-Q^{a}-]ⱼ₃₂Z³²[-Q^{b}-Si(R)ₙL₃₋ₙ]ₕ₃₂ (3-2)

In the formula (3-2), A, X, m1, Q^{a}, Q^{b}, R and L are as defined for the groups in the formulae (3-1) and (3-1A).

Z³² is a (j32+h32) valent hydrocarbon group, or a (j32+h32) valent hydrocarbon group having at least 2 carbon atoms and having an etheric oxygen atom between carbon atoms.

Z³² is preferably a residue having a hydroxy group removed from a polyhydric alcohol having a primary hydroxy group.

Z³² is, in view of availability of raw materials, preferably a group represented by any one of the formulae (Z-1) to (Z-5), wherein R³⁴ is an alkyl group and is preferably a methyl group or an ethyl group.

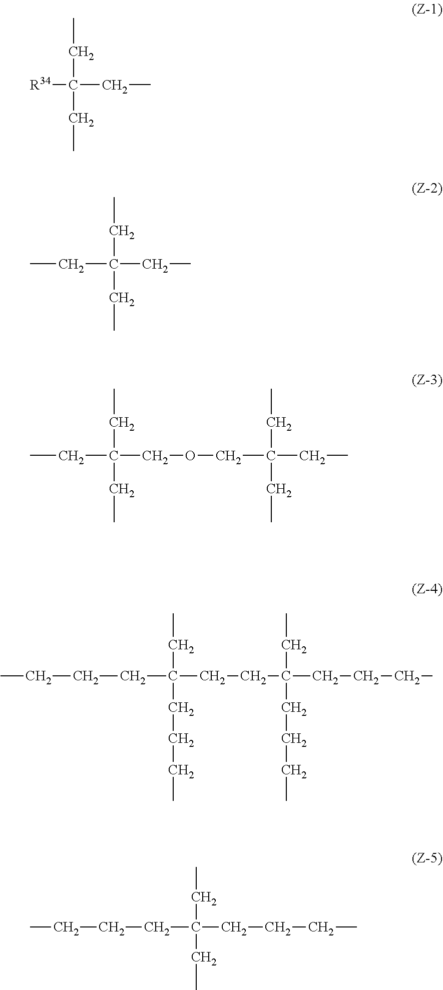

j32 is an integer of at least 2, and in view of more excellent water/oil repellency of the film, preferably an integer of from 2 to 5.

h32 is an integer of at least 1, and in view of more excellent abrasion resistance of the film, preferably an integer of from 2 to 4, more preferably 2 or 3.

As specific examples of the fluorinated ether compound, compounds described in the following documents may be mentioned.

Perfluoropolyether-modified aminosilanes described in JP-A-H11-029585,

silicon-containing organic fluorinated polymers described in Japanese Patent No. 2874715,

organic silicon compounds described in JP-A-2000-144097,

perfluoropolyether-modified aminosilanes described in JP-A-2000-327772,

fluorinated siloxanes described in JP-A-2002-506887,

organic silicone compounds described in JP-A-2008-534696,

fluorinated modified hydrogen-containing polymers described in Japanese Patent No. 4138936,

compounds described in U.S. Patent Application No. 20100129672, WO2014/126064 and JP-A-2014-070163,

organosilicon compounds described in WO2011/060047 and WO02011/059430,

fluorinated organosilane compounds described in WO2012/064649,

fluorooxyalkylene group-containing polymers described in JP-A-2012-72272,

fluorinated ether compounds described in WO2013/042732, WO2013/121984, WO2013/121985, WO2013/121986, WO2014/163004, JP-A-2014-080473, WO2015/087902, WO2017/038830, WO2017/038832 and WO2017/187775,

perfluoro(poly)ether-containing silane compounds described in JP-A-2014-218639, WO2017/022437, WO2018/079743 and WO2018/143433,

fluoropolyether group-containing polymer-modified silanes described in JP-A-2015-199906, JP-A-2016-204656, JP-A-2016-210854 and JP-A-2016-222859, and fluorinated ether compounds described in WO2018/216630, WO2019/039226, WO2019/039341, WO2019/039186, Japanese Patent Application No. 2017-167973, Japanese Patent Application No. 2017-167999 and Japanese Patent Application No. 2017-251611.

As commercial products of the fluorinated ether compound, KY-100 series (KY-178, KY-185, KY-195, etc.) manufactured by Shin-Etsu Chemical Co., Ltd, Afluid (registered trademark) S550 manufactured by AGC Inc., OPTOOL (registered trademark) DSX, OPTOOL (registered trademark) AES, OPTOOL (registered trademark) UF503 and OPTOOL (registered trademark) UD509, etc. manufactured by DAIKIN INDUSTRIES, LTD. may be mentioned.

### (Form)

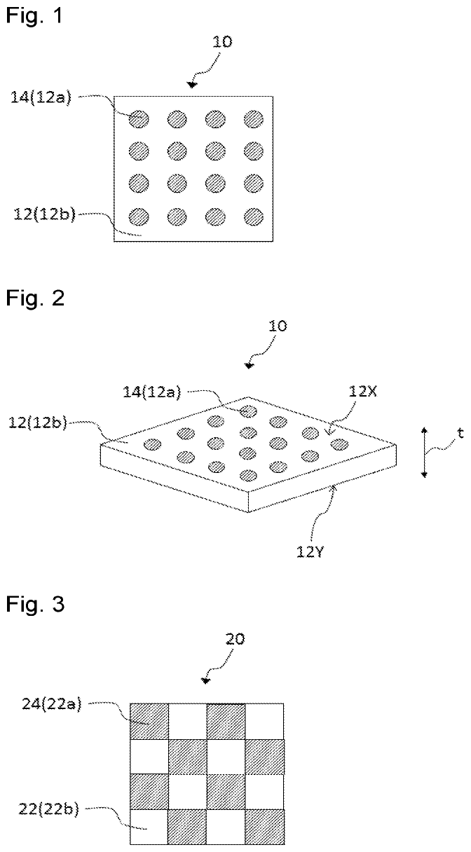

The form (shape) of the first film is not particularly limited, and in view of more excellent effects of the present invention, preferably any one or combination of the following. Now, a preferred form of the first film will be described with reference to drawings. FIGS. 1 to 6 illustrate an example using a plate-form substrate.

FIG. 1 is a schematic plan view illustrating an example of a substrate with a film of the present invention. As shown in FIG. 1, the substrate with a film 10 comprises a substrate 12 and a first film 14 disposed on a plurality of first regions 12a in dots on the principal plane of the substrate 12. A second region 12b on the principal plane of the substrate 12 is exposed to the principal plane of the substrate with a film 10.

Here, the principal plane of the plate-form substrate 12 means a surface of one plane among a plurality of planes constituting the substrate 12. Specifically, in a case where the substrate 12 is in a plate form as shown in FIG. 2 (a schematic oblique view illustrating the substrate with a film 10), the principal plane is, among two planes vertical to the thickness direction t of the substrate 12 (that is, planes 12X and 12Y, in other words, two main planes), one plane (in FIG. 2, the plane 12X, in other words, one main plane). The principal plane of the substrate in the following FIGS. 3 to 6 is as defined in the same manner as the principal plane of the substrate in FIG. 1.

The shape of the dot of the first film 14 is circular but is not limited thereto, and may, for example, be elliptic, long circular, a shape having long circles intersecting, polygonal (for example, triangular, quadrangular, pentagonal, hexagonal, cruciform or asteroid), or a round polygonal shape having corners of the above polygon rounded. Among them, in view of the production efficiency of the first film 14, the shape is preferably circular, elliptic or quadrangular.

The shapes of the plurality of dots of the first film 14 may be the same or different, and are preferably the same as shown in FIG. 1.

The size of the dot of the first film 14 is, in view of more excellent effects of the present invention, preferably from 10 to 1,500 μm, more preferably from 50 to 8,000 μm. The size of the dot of the first film 14 means, in a case where the dot of the first film 14 is circular, the diameter, and in other cases, the equivalent circle diameter calculated from the area of the first film 14.

The sizes of the plurality of dots of the first film 14 may be the same or different, and are preferably the same as shown in FIG. 1.

The dots of the first film 14 are arranged at constant intervals in a tetragonal lattice, but the arrangement is not limited thereto, and they may be arranged in a lattice other than the tetragonal lattice (for example, hexagonal lattice, rectangular lattice or orthorhombic lattice), or may be arranged randomly. The distance between adjacent dots of the first film 14 is, in view of more excellent effects of the present invention, preferably from 10 to 1,500 μm, particularly preferably from 50 to 1,000 μm.

FIG. 3 is a schematic plan view illustrating an example of a substrate with a film of the present invention, specifically, illustrating a modified example of the embodiment in which the first film is disposed on a plurality of the first regions in dots on the principal plane of the substrate. The constitution of the substrate with a film 20 shown in FIG. 3 is substantially the same as the constitution of the substrate with a film 10 shown in FIG. 1 except that the shape of the plurality of the first regions in the substrate with a film 20 in FIG. 3 is different from the shape of the plurality of the first regions in the substrate with a film 10 in FIG. 1.

As shown in FIG. 3, a first film 24 is disposed on first regions 22a arranged in a checkered flag form on the principal plane of the substrate 22. That is, on the principal plane of the substrate with a film 20, the first film 24 and an exposed portion of the substrate 22 (second region 22b) are alternately present.

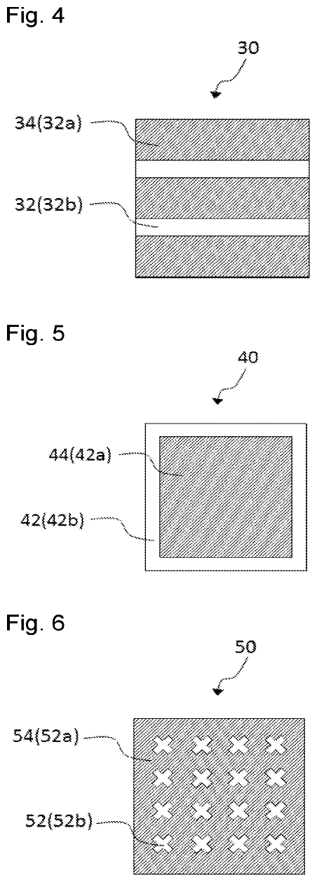

FIG. 4 is a schematic plan view illustrating an example of a substrate with a film of the present invention. As shown in FIG. 4, the substrate with a film 30 comprises a substrate 32 and a first film 34 disposed on a strip first region 32a on the principal plane of the substrate 32. A second region 32b on the principal plane of the substrate 32 is exposed to the principal pane of the substrate with a film 30.

The shape of the first film 34 is a strip straight line but is not limited thereto, and may be a strip curve (for example, wave line) or may be a strip polygonal line (for example, herringbone). The shapes of the plurality of strips of the first film 34 may be the same or different, and are preferably the same as shown in FIG. 4. The width of the strip of the first film 34 is, in view of more excellent effects of the present invention, preferably from 10 to 100,000 μm (10 cm), more preferably from 50 to 20,000 μm (2 cm). The widths of the plurality of the strips of the first film 34 may be the same or different, and are preferably the same as shown in FIG. 4.

The strips of the first film 34 are arranged at constant intervals, but the arrangement is not limited thereto, and the intervals between the strips of the first film 34 may be different. The interval between the strips of the first film 34 is, in view of more excellent effects of the present invention, preferably from 10 to 1,500 μm, more preferably from 50 to 800 μm.

FIG. 5 is a schematic plan view illustrating an example of a substrate with a film of the present invention. A substrate 42 has, on its principal plane, a peripheral region 42b (second region 42b) and a center region 42a (first region 42a) surrounded by the peripheral region 42b. As shown in FIG. 5, the substrate with a film 40 comprises the substrate 42 and a first film 44 disposed on the center region 42a. The peripheral region 42b on the principal plane of the substrate 42 is exposed to the principal plane of the substrate 40 with a film.

The shape of the first film 44 is quadrangular (more particularly rectangular) but is not limited thereto and may, for example, circular, elliptic, long circular, a shape having long circles intersecting, polygonal (for example, triangular, pentagonal, hexagonal, cruciform or asteroid), or a round polygonal shape having corners of the above polygon rounded. Among them, in view of more excellent effects of the present invention, the shape is preferably quadrangular.

The area of the first film 44 may be suitably determined depending upon the area of the principal plane of the substrate and is preferably determined so that the area ratio of the area of the first film 44 to the area of the peripheral region 42b is in the after-described relation.

FIG. 6 is a schematic plan view illustrating an example of a substrate with a film of the present invention. A substrate 52 has on its principal plane a plurality of dotted dispersed regions 52b (second region 52b) and a continuous region 52a (first region 52a) other than the dispersed regions 52b. As shown in FIG. 6, the substrate with a film 50 comprises the substrate 52 and a first film 54 disposed on the continuous region 52a. The dispersed region 52b on the principal plane of the substrate 52 is exposed to the principal plane of the substrate with a film 50.

It is considered that the dispersed regions 52b correspond to a dispersed phase (islands) of a sea-island structure, and the continuous region 52a corresponds to a continuous phase (sea) in the sea-island structure.

The shape of each dispersed region 52b is cruciform (more particularly, alphabet X) but is not limited thereto and may, for example, circular, elliptic, long circular, a shape having long circles intersecting, polygonal (for example, triangular, quadrangular, pentagonal or asteroid), or a round polygonal shape having corners of the above polygon rounded. Among them, in view of more excellent effects of the present invention, the shape is preferably quadrangular.

The shapes of the plurality of the dispersed regions 52b may be the same or different and are preferably the same as shown in FIG. 6.

The size of each dispersed region 52b is, in view of more excellent effects of the present invention, preferably from 10 to 1,500 μm, more preferably 50 to 800 μm. The size of the dispersed region means, in a case where the shape of the first region 52b is circular, the diameter, and in other cases, the equivalent circle diameter calculated from the area of the dispersed region 52b.

The sizes of the plurality of the dispersed regions 52b may be the same or different and are preferably the same as shown in FIG. 6.

The dispersed regions are arranged at constant intervals, but the arrangement is not limited thereto, and the dispersed regions 52b may be arranged randomly. The distance between adjacent dispersed regions 52b is, in view of more excellent effects of the present invention, preferably from 10 to 100, 000 μm (10 cm), more preferably from 50 to 20,000 μm (2 cm).

With respect to the principal plane of the substrate with a film in each of FIGS. 1 to 6, a part of the principal plane of the substrate is exposed at a portion where the first film is not disposed, but the present invention is not limited to such an embodiment, and a second film (described hereinafter) having no poly(oxyfluoroalkylene) chain may be disposed on at least a part of the second region on the principal plane of the substrate.

The area ratio of the first region to the second region (area of the first region/area of the second region) is preferably from 0.3 to 50.0, more preferably from 0.5 to 45.0, particularly preferably from 0.6 to 40.0. When the area ratio is at least 0.3, the substrate with a film will be more excellent in fingerprint stain removability. When the area ratio is at most 50.0, the substrate with a film will be more excellent in sliding resistance.

In a case where the substrate is composed of a material containing silicon atoms (preferably glass), the rate of the principal plane of the substrate with a film covered with the first film is preferably from 20 to 97%, more preferably from 50 to 95%, particularly preferably from 60 to 93%. When the rate covered with the first film is at least 20%, the substrate with a film will be more excellent in fingerprint stain removability. Particularly when the rate covered with the first film is at least 60%, the substrate with a film will be excellent in fingerprint stain removability and the substrate with a film will also be excellent in abrasion resistance. When the rate covered with the first film is at most 97%, the substrate with a film will be more excellent in sliding resistance.

In calculation of the coverage rate, the principal plane of the substrate with a film means a surface on which the first film is formed (for example, plane 12X in FIG. 2).

The rate covered with the first film is calculated by obtaining F₂⁻ mapping images of the principal plane of the substrate with a film by time-of-flight secondary ion mass spectrometry (TOF-SIMS), and image-analyzing the images. The value calculated in such a manner will be taken as the rate covered with the first film.

The second region preferably has a block continuous certain area. The continuous area of the second region is preferably at least 0.001 mm² and at most 1 cm², more preferably at least 0.01 mm² and at most 0.1 cm². When it is at least 0.001 mm², the substrate with a film will have favorable sliding resistance. When it is at most 1 cm², the substrate with a film will be excellent in fingerprint stain removability.

### (Physical Properties)

The difference between the dynamic friction coefficient a of the first film and the dynamic friction coefficient b of a portion corresponding to the second region on the principal plane of the substrate with a film (dynamic friction coefficient b-dynamic friction coefficient a) is preferably from 0.01 to 0.99, more preferably from 0.05 to 0.6, particularly preferably from 0.1 to 0.5. When the difference in the dynamic friction coefficient is at least 0.01, the substrate with a film will be more excellent in fingerprint stain removability. When the difference in the dynamic friction coefficient is at most 0.99, the substrate with a film will be more excellent in sliding resistance.

The dynamic friction coefficient of a portion corresponding to the second region on the principal plane of the substrate with a film means, in a case where the second film (described hereinafter) is formed on the second region, the dynamic friction coefficient of the second film, and in a case where no second film is formed on the second region, the dynamic friction coefficient of the substrate.

The dynamic friction coefficient a is preferably from 0.01 to 0.4, particularly preferably from 0.01 to 0.3.

The dynamic friction coefficient b is preferably higher than 0.4, particularly preferably from 0.5 to 0.8.

As the dynamic friction coefficient, the dynamic friction coefficient of a portion corresponding to the first film or the second region to an artificial skin (manufactured by Idemitsu Technofine Co., Ltd., PBZ13001) is measured by means of a load variation type friction abrasion test system (manufactured by Shinto Scientific Co., Ltd., HHS2000) under conditions of a contact area of 3 cm×3 cm and a load of 0.98 N.

The film thickness of the first film is preferably from 1 to 100 nm, particularly preferably from 1 to 50 nm. The film thickness of the first film can be calculated from an oscillation period of an interference pattern of reflected X-ray, obtained by X-ray reflectance method using an X-ray diffractometer for thin film analysis (ATX-G, tradename, manufactured by Rigaku Corporation).

### [Second Film]

With respect to the principal plane (surface on the side on which the first film is disposed) of the substrate with a film, the portion corresponding to the second region of the substrate may be composed of the substrate itself (that is, the substrate is exposed) or may be composed of a film having no poly(oxyfluoroalkylene) chain (hereinafter sometimes referred to as “second film”).

As specific examples of the second film, a primary film formed on the principal plane of the substrate obtained by subjecting the substrate to primary coat treatment with e.g. compounds described in WO2011/016458, paragraphs 0089 to 0095 or with SiO₂, may be mentioned.

The second film may be formed on the whole second region or may be formed on a part of the second region.

[Process for Producing Substrate with Film]

The substrate with a film of the present invention may be produced by disposing the first film only on the first region on the principal plane of the substrate.

More specifically, the first film may be formed only on the first region on the principal plane of the substrate by using the fluorinated ether compound or a composition containing the fluorinated ether compound and a liquid medium (hereinafter sometimes referred to as “composition”), either by dry coating or wet coating.

As specific examples of the liquid medium contained in the composition, water and an organic solvent may be mentioned. As specific examples of the organic solvent, a fluorinated organic solvent and a non-fluorinated organic solvent may be mentioned.

The organic solvent may be used alone or in combination of two or more.

Specific examples of the fluorinate organic solvent, a fluorinated alkane, a fluorinated aromatic compound, a fluoroalkylether, a fluorinated alkylamine and a fluoroalcohol may be mentioned.

The fluorinated alkane is preferably a C₄₋₈ compound and may, for example, be C₆F₁₃H (AC-2000, tradename, manufactured by AGC Inc.), C₆F₁₃C₂H₅ (AC-6000, tradename, manufactured by AGC Inc.), and C₂F₅CHFCHFCF₃(Vertrel, tradename, manufactured by DuPont) may be mentioned.

As specific examples of the fluorinated aromatic compound, hexafluorobenzene, trifluoromethylbenzene, perfluorotoluene, 1,3-bis(trifluoromethyl)benzene and 1,4-bis(trifluoromethyl)benzene may be mentioned.

The fluoroalkyl ether is preferably a C₄₋₁₂ compound and may, for example, be CF₃CH₂OCF₂CF₂H (AE-3000, tradename, manufactured by AGC Inc.), C₄F₉OCH₃ (Novec-7100, tradename, manufactured by 3M), C₄F₉OC₂H₅ (Novec-7200, tradename, manufacture by 3M), and C₂F₅CF(OCH₃)C₃F₇ (Novec-7300, tradename, manufactured by 3M) may be mentioned.

As specific examples of the fluorinated alkylamine, perfluorotripropylamine and perfluorotributylamine may be mentioned.

As specific examples of the fluoroalcohol, 2,2,3,3-tetrafluoropropanol, 2,2,2-trifluoroethanol and hexafluoroisopropanol may be mentioned.

The non-fluorinated organic solvent is preferably a compound composed solely of hydrogen atoms and carbon atoms or a compound composed solely of hydrogen atoms, carbon atoms and oxygen atoms, and may be specifically a hydrocarbon organic solvent, a ketone organic solvent, an ether organic solvent, an ester organic solvent or an alcohol organic solvent.

Specific examples of the hydrocarbon organic solvent, hexane, heptane and cyclohexane may be mentioned.

Specific examples of the ketone organic solvent, acetone, methyl ethyl ketone and methyl isobutyl ketone may be mentioned.

Specific examples of the ether organic solvent, diethyl ether, tetrahydrofuran and tetraethylene glycol dimethyl ether may be mentioned.

Specific examples of the ester organic solvent, ethyl acetate and butyl acetate may be mentioned.

Specific examples of the alcohol organic solvent, isopropyl alcohol may be mentioned.

The content of the fluorinated ether compound in the composition is preferably from 0.01 to 50.00 mass %, particularly preferably from 1.0 to 30.00 mass % to the total mass of the composition.

The content of the liquid medium in the composition is preferably from 50.00 to 99.99 mass %, particularly preferably from 70.00 to 99.00 mass % to the total mass of the composition.

The substrate with a film may be produced, for example, be the following method.

A method of treating the principal plane of the substrate by dry coating method using the fluorinated ether compound or the composition to obtain the substrate with a film having the first film disposed only on the first region on the principal plane of the substrate.

A method of applying the composition to the principal plane of the substrate by wet coating method, followed by drying to obtain an article having the first film disposed only on the first region on the principal plane of the substrate.

As specific examples of the dry coating method, vacuum deposition method, CVD method or sputtering method may be mentioned. With a view to suppressing decomposition of the fluorinated ether compound and from the viewpoint of simplicity of apparatus, vacuum deposition method is preferred. At the time of vacuum deposition, a pelletized material having a metal porous product of iron, steel of the like impregnated with the fluorinated ether compound or the composition may also be used.

In a case where the dry coating method is employed, as the method of disposing the first film only on the first region on the principal plane of the substrate, a method of disposing a mask having a shape corresponding to the first film on the principal plane of the substrate and treating the principal plane of the substrate by the dry coating method may be mentioned.

As specific examples of the mask, a metal mesh having openings formed, a punched sheet having holes formed, an adhesive tape, and printing e.g. by a resin or a coating material may be mentioned.

The wire diameter of the metal mesh is, in order that the rate covered with the first film is easily adjusted to be within the above range, preferably from 80 to 500 μm, particularly preferably from 100 to 500 μm.

The aperture of the metal mesh is, in order that the rate covered with the first film is easily adjusted to be within the above range, preferably from 150 to 2,000 μm, particularly preferably from 200 to 1,500 μm.

The distance between holes of the punched sheet is, in order that the rate covered with the first film is easily adjusted to be within the above range, preferably from 70 to 1,000 μm, particularly preferably from 70 to 700 μm.

The aperture of the punched sheet is, in order that the rate covered with the first film is easily adjusted to be within the above range, preferably from 100 to 1,000 μm, particularly preferably from 200 to 700 μm.

Use of an adhesive tape as the mask and use of coating, particularly printing, with a resin or a coating material, as the mask, is preferred in that the shape of figures such as circles or quadrangles, characters and patterns can freely be adjusted. The resin and the coating material may be curable or plastic, and are preferably photocurable in that the shape can easily be adjusted. Further, such a resin and a coating material are preferably easily soluble in water or a solvent, whereby the coating can readily be separated.

As specific examples of the wet coating method, spin coating method, wipe coating method, spray coating method, squeegee coating method, dip coating method, die coating method, ink-jet method, flow coating method, roll coating method, casting method, Langmuir-Blodgett method, and gravure coating method may be mentioned.

In a case where the wet coating method is employed, as a method of disposing the first film only on the first region on the principal plane of the substrate, in the same manner as the dry coating method, a mask may be disposed on the principal plane of the substrate and then the composition is applied to the principal plane of the substrate by the wet coating method.

Use of an adhesive tape as the mask and use of coating, particularly printing, with a resin or a coating material, as the mask, is preferred in that the shape of figures such as circles or quadrangles, characters and patterns can freely be adjusted.

Among the wet coating methods, by the ink-jet method, the first film cab be disposed only on the first region on the principal plane of the substrate without using a mask.

The first film formed by the above procedure includes compounds obtained by hydrolytic reaction and condensation reaction of the fluorinated ether compound.

### [Other Application]

The substrate with a film of the present invention may be applicable also to articles which are required to have design property. Specifically, it may be applicable to e.g. glass and a resin to be used for a building material, a decorative building material, an interior article, a transport, an advertising display/bulletin board, a beverage container/tableware, an aquarium, an ornamental instrument, a laboratory instrument, furniture, and art/sports/games. The substrate may be in a plate form or in a film form.

Since such a substrate has regions differing in the surface free energy formed on its surface, when a water droplet is attached, the shape of the region on which the water droplet is attached changes. By this change, light scattering, reflection and transmission change, whereby a design such as characters or patterns is displayed.

Specifically, for example, when tableware or beverage glass is cooled by pouring cold water or the like, characters, symbols or patterns show themselves. Further, for example, when window glass, a mirror, an aquarium, a bulletin board or glass to be used for sports/games has dew condensation, characters, symbols, patterns, a picture of a design shows itself. As a method of forming dew condensation, a method of making a temperature difference between the substrate and the air e.g. by cooling or temperature increase or a method of increasing humidity may, for example, be mentioned. Specifically, a cooling method e.g. with ice, a humidification method and a blowing method may be mentioned.

Further, since the substrate has regions differing in the surface free energy formed on its surface, when fingerprints, an oil or stains are attached, light scattering, reflection and transmission change in accordance with the amount attached, whereby a design such as characters or patterns is displayed. Specifically for example, such an application may be mentioned that fingerprints are attached by touching the rear side of a smartphone or glass to be used for sports/games, whereby characters, symbols, patterns, a picture or a design shows itself in accordance with the difference in the amount of the fingerprints attached among regions differing in the fingerprint adhesion property.

Further, applications may be mentioned such that water is poured into tableware, an aquarium or glass to be used for sport/games/art, whereby a pattern shows itself in accordance with whether water is present or not at a water repellent portion which repels water and a hydrophilic portion at which water settles, and that a liquid is poured into a glass container used for a laboratory instrument, and a portion at which the liquid settles is separated.

### EXAMPLES

Now, the present invention will be described in further detail with reference to Examples. However, it should be understood that the present invention is by no means restricted thereto. Among Ex. 4 to 18, Ex. 5 to 7, 10, 12, 13, 15, 17 and 18 are Examples of the present invention, and 4, 8, 9, 11, 14 and 16 are Comparative Examples.

### [Evaluation Methods]

### (Rate Covered)

By an apparatus (TOF.SIMS5, tradename, manufactured by ION-TOF) employing time-of-flight secondary ion mass spectrometry (TOF-SIMS) as measurement principle, the principal plane (the plane having the first film disposed thereon) of the substrate with a film was analyzed, and by means of an analysis software (Surface Lab 6.7), F₂⁻ mapping images were binned at 64 pixels to conduct ROI (Region Of Interest) analysis. Taking the minimum threshold being 40% and the maximum threshold being 100%, whether the principal plane was covered or not was evaluated in every binned region, and the ratio (%) of the number of the regions evaluated to be covered to the total number of regions binned was calculated. The ratio (%) was taken as the rate covered with the first film.

Conditions of measurement by TOF-SIMS are as follows.

Measurement mode: High Current Bunched Mode

Primary ion species: Bi₅⁺⁺

Accelerating voltage of primary ions: 25 kV

Current or primary ions: 0.05 pA at 10 kHz

Cycle time: 100 μs

Mapping mode: 2D Large Area Mode

Raster: sawtooth, 1 shots/pixel

Number of scans: 1

Frames per patch: 8

Field of analysis: 5×5 mm²

Pixel density: 256 pixel/mm

Maximum Patch Side Length: 0.25 mm

Extractor of detector in a state without surface potential modification: 2,000 V

Energy of detector in a state with surface potential modification: 2,000 V

Electron gun: used

### (Water Contact Angle)

The contact angle (water contact angle) of about 2 μL of distilled water placed on the principal plane (the plane having the first film disposed thereon) of the substrate with a film was measured by using a contact angle measuring apparatus (DM-500, tradename, manufactured by Kyowa Interface Science Co., Ltd.). Measurements were conducted at five different points on the principal plane, and the average value was calculated. For the calculation of the contact angle, a 2θ method was employed.

⊚ (good): The contact angle being at least 100 degrees.

◯ (acceptable): The contact angle being at least 80 degrees and less than 100 degrees.

× (poor): The contact angle being less than 80 degrees.

### (Fingerprint Stain Removability)

Fingerprints attached to the principal plane (the plane having the first film disposed thereon) of the substrate with a film was wiped off by a cellulose nonwoven fabric (BEMCOT M-3, tradename, manufactured by Asahi Kasei Corporation), and whether the fingerprints were readily wiped off or not was visually evaluated. The evaluation standards are as follows.

⊚ (good): Fingerprints completely wiped off.

◯ (acceptable): Fingerprint stains remain.

× (poor): Fingerprint stains spread and cannot be wiped off.

### (Abrasion Resistance)

With respect to the evaluation sample after the abrasion resistance test, the above test to evaluate fingerprint stain removability was conducted, and fingerprint stain removability was evaluated under the same evaluation standards. The more excellent fingerprint stain removability after the abrasion resistance test, the smaller the decrease of the performance by abrasion, and the more excellent the abrasion resistance.

### <Abrasion Resistance Test>

With respect to the principal plane (the plane having the first film disposed thereon) of the substrate with a film, in accordance with JIS L0849:2013 (ISO 105-X12:2001), using a reciprocating traverse testing machine (manufactured by KNT Co.), cellulose nonwoven fabric (BEMCOT M-3, tradename, manufactured by Asahi Kasei Corporation) was reciprocated 10,000 times under a load of 1 kg with a rubbing length of 4 cm at a speed of 30 rpm.

### (Sliding Resistance)

An automatic contact angle meter (DMo-701, tradename, manufactured by Kyowa

Interface Science Co., Ltd.), the principal plane of which was kept horizontally, was prepared. On the surface (horizontal plane) of a polyethylene sheet (rigid polyethylene sheet (high density polyethylene): tradename, manufactured by HAGITEC CO., LTD.), the substrate with a film was placed so that the plane having the first film deposited thereon (principal plane) was in contact with the polyethylene sheet, and gradually inclined by using the automatic contact angle mater, and an angle (sliding angle) formed by the plane having the first film formed thereon of the substrate with a film and the horizontal plane when the substrate with a film started sliding was measured. The evaluation standards are as follows. Measurement was conducted under conditions such that the contact area between the substrate with a film and the polyethylene sheet was 6 cm×6 cm, and a load of 0.98 N was applied to the substrate with a film.

⊚ (good): The sliding angle being at least 5 degrees.

◯ (acceptable): The sliding angle being at least 2 degrees and less than 5 degrees.

× (poor): The sliding angle being less than 2 degrees.

### Ex. 1

### Preparation Example

Compound 3A was obtained in accordance with the method for producing compound (ii-2) in WO2014/126064.

Compound 3A: CF₃CF₂—OCF₂CF₂—(OCF₂CF₂CF₂CF₂OCF₂CF₂)_{mA}—OCF₂CF₂CF₂—C(O)NH—CH₂CH₂CH₂—Si(OCH₃)₃

Mean value of mA: 13, number average molecular weight of compound 3A: 4,920.

### Ex. 2

### Preparation Example

Compound 3B was obtained in accordance with the method described in Ex. 2 of WO2017/038832.

Compound 3B: CF₃CF₂CF₂—OCHFCF₂—OCH₂CF₂—{(OCF₂)_{mB1}(OCF₂CF₂)_{mB2}}—OCF₂—CH₂—N[CH₂CH₂CH₂—Si(OCH₃)₃]₂

Mean value of mB1: 21, mean value of mB2: 20, number average molecular weight of compound 3B: 4,470.

### Ex. 3

### Preparation Example

Compound 3C was obtained in accordance with the method described in Ex. 11 of WO2017/038830.

Compound 3C: CF₃—(OCF₂CF₂OCF₂CF₂CF₂CF₂)_{mC}(OCF₂CF₂)—OCF₂CF₂CF₂—C(O)NH—CH₂—C[CH₂CH₂CH₂—Si(OCH₃)₃]₃

Mean value of mC: 13, number average molecular weight of compound 3C: 5,400.

### Ex. 4

The compound 3A and hydrofluoroether (Novec HFE7200, tradename, manufactured by 3M) were mixed to obtain a composition having a concentration of the compound 3A of 20 mass %.

Using the obtained composition, a substrate was subjected to surface treatment by the following vacuum deposition method to obtain an evaluation sample (substrate with a film) comprising chemically tempered glass (Dragontrail glass, tradename, manufactured by AGC Inc.) as the substrate and a first film formed on a part of the principal plane of the glass. The surface treatment of the substrate was conducted after a mask (metal mesh manufactured by Misumi, aperture: 80 μm, wire diameter: 50 μm) having holes was bonded to the principal plane of the substrate.

Specifically, under a vacuum deposition pressure of 3.0×10⁻³ Pa, a silicon dioxide film (film thickness: 7 nm) was formed on the principal plane of the substrate, and then 2 mg of the composition (that is, 0.4 mg of the compound 3A) was deposited per sheet (55 mm×100 mm) of chemically tempered glass. Then, in an atmosphere at a temperature of 20° C. under a humidity of 65%, the substrate with a deposited film was left at rest for 24 hours and then washed with AK-225 (tradename, manufactured by AGC Inc.) to obtain an evaluation sample (substrate with a film) having the first film disposed on a part of the principal plane of the substrate.

The principal plane (plane having the first film disposed thereon) of the obtained evaluation sample was confirmed from the image analysis results of F₂⁻ stage scanning mapping images, whereupon the vacuum deposited composition was disposed on a portion shielded with the mask, and the first film was disposed on the whole principal plane. The reason is considered to be such that since the wire diameter of the metal mesh is small, the adhesion between the substrate and the mask decreased.

Using the obtained evaluation sample, the above evaluation tests were conducted and the results are shown in Table 1.

### Ex. 5 to 18

Evaluation samples (substrates with a film) were obtained in the same manner as in Ex. 4 except that the types of the fluorinated ether compound and the mask were changed as identified in Table 1.

Specifically, in Ex. 5, 6, 9, 10 and 12, a metal mesh (manufactured by Misumi) having an aperture and a wire diameter as identified in Table 1 was used as the mask. In Ex. 7, 13, 15 and 17, a copper foil punched sheet (manufactured by Fukuda Metal Foil & Powder Co., Ltd.) having an aperture and a distance between holes as identified in Table 1 was used as the mask. In Ex. 8, 11, 14 and 16, no mask was used.

Further, in Ex. 18, the following evaluation sample was prepared. A glass substrate was coated with a photocurable coating material (RIP-1C manufactured by Jujo Chemical Co., Ltd.), and using as a mask a punched metal having an aperture of 100 μm and a hole distance of 110 μm, irradiated with metal halide lamp. The glass substrate was washed with warm water to remove an uncured coating material, whereby a glass substrate having a cured film printed in circles was prepared. Vacuum deposition was conducted in the same manner as in Ex. 4 except that the compound 3B was used instead of the compound 3A. The printed cured film was removed by an ultrasonic cleaner in a state where the glass substrate was immersed in ethanol. The remaining coating material was physically peeled. A sample having the compound 3B attached to a part other than the printed portion (portion of holes of the punched metal) (having the compound 3B attached in the same shape as the shape of the punched metal) was obtained.

The fluorinated ether compound used in Ex. 15 and 16 is OPTOOL UD509 (tradename, manufactured by DAIKIN INDUSTRIES, LTD) and is a compound having a poly(oxyfluoroalkylene) chain and a reactive silyl group.

In Ex. 5 to 7, 9, 10, 12, 13, 15, 17 and 18, from the image analysis results of F₂⁻ stage scanning mapping images of the principal plane (the plane having the first film disposed thereon) of the obtained evaluation sample, formation of the first film in each shape as identified in Table 1 was confirmed. The shape of the first film 1 is shown in Table 1.

However, in Ex. 9, the vacuum deposited composition was disposed on a portion shielded with the mask, and the first film was disposed on the whole principal plane. The reason is considered to be such that since the wire diameter of the metal mesh is small, adhesion between the substrate and the mask decreased.

Using the obtained evaluation samples, the above evaluation tests were conducted, and the results are shown in Table 1.

TABLE 1

| | | Mask | | | | | | | |
|---|---|---|---|---|---|---|---|---|---|
| | | | Wire diameter or | Rate | | | Fingerprint | | |
| | Fluorinated ether | Aperture | distance between | covered | Shape of | Contact | stain | Abrasion | Sliding |
| | compound | (μm) | holes (μm) | (%) | first film | angle | removability | resistance | resistance |
| Ex. 4 | Compound 3A | 80 | 50 | 100 | — | ⊚ | ⊚ | ◯ | X |
| Ex. 5 | Compound 3A | 560 | 290 | 70 | Rectangle | ⊚ | ⊚ | ◯ | ◯ |
| Ex. 6 | Compound 3A | 1300 | 290 | 92 | Strip | ⊚ | ⊚ | ◯ | ◯ |
| Ex. 7 | Compound 3A | 400 | 400 | 50 | Circle | ◯ | ◯ | X | ⊚ |
| Ex. 8 | Compound 3A | — | — | 100 | — | ⊚ | ⊚ | ◯ | X |
| Ex. 9 | Compound 3B | 80 | 50 | 100 | — | ⊚ | ⊚ | ⊚ | X |
| Ex. 10 | Compound 3B | 560 | 290 | 70 | Rectangle | ⊚ | ⊚ | ⊚ | ◯ |
| Ex. 11 | Compound 3B | — | — | 100 | — | ⊚ | ⊚ | ⊚ | X |
| Ex. 12 | Compound 3C | 560 | 290 | 70 | Rectangle | ⊚ | ⊚ | ⊚ | ◯ |
| Ex. 13 | Compound 3C | 300 | 100 | 95 | Dots | ⊚ | ⊚ | ◯ | ◯ |
| Ex. 14 | Compound 3C | — | — | 100 | — | ⊚ | ⊚ | ⊚ | X |
| Ex. 15 | OPTOOL UD509 | 400 | 400 | 50 | Circle | ◯ | ◯ | X | ⊚ |
| Ex. 16 | OPTOOL UD509 | — | — | 100 | — | ⊚ | ⊚ | ⊚ | X |
| Ex. 17 | Compound 3B | 300 | 300 | 35 | Circle | ⊚ | ⊚ | ◯ | ◯ |
| Ex. 18 | Compound 3B | 100 | 100 | 77 | * | ⊚ | ⊚ | ◯ | ◯ |

* Shape having circles punched

As shown in Table 1, it is confirmed that by disposing the first film only on a part of region on the principal plane of the substrate (Ex. 5 to 7, 10, 12, 13, 15, 17 and 18), a substrate with a film excellent in fingerprint stain removability and sliding resistance is obtained.

Whereas it is confirmed that in a case where the first film is disposed on the whole region of the principal plane of the substrate (Ex. 4, 8, 9, 11, 14 and 16), the substrate with a film is inferior in sliding resistance.

### INDUSTRIAL APPLICABILITY

The substrate with a film of the present invention is useful for various applications for which it is required to impart water/oil repellency. For example, it may be used for a display input device such as a touch panel; a transparent glass or transparent plastic member, kitchen antifouling member; water repellent moistureproof member or antifouling member of electronic device, a heat exchanger or a battery, etc.; toiletry antifouling member; a member which requires liquid repellency while conducting electricity; a water repellent/waterproof/water sliding member of a heat exchanger; or a surface low friction member of the inside of a vibrating strainer or a cylinder, etc. More specific examples of application include a front protective plate, an antireflection plate, a polarizing plate, an antiglare plate or a surface thereof having an antireflection film, of a display, an apparatus having a display input device of which the screen is operated by human hands or fingers, such as a touch panel sheet or a touch panel display of an apparatus such as a mobile phone (for example a smartphone), a personal digital assistant, a gaming machine or a remote controller (for example, glass or a film to be used for e.g. a display part, or glass or a film to be used for an exterior member other than a display part), a decorative building material for restroom, bathroom, lavatory, kitchen and the like, a waterproof member for a wiring board, a water repellent/waterproof/water sliding member of a heat exchanger, a water repellent member of a solar cell, a waterproof/water repellent member of a printed wiring board, a waterproof/water repellent member of an electronic equipment casing or an electronic member, an insulating property-improving member of a power transmission line, a waterproof/water repellent member of a filter, a waterproof member of an electromagnetic wave absorption material or an acoustic material, an antifouling member for bathroom, kitchen instrument and toiletry, a surface low-friction member of the inside of a vibrating strainer or a cylinder, a surface protective member of a machine component, a vacuum apparatus component, a bearing component, a member for a transport such as an automobile, an industrial tool, etc.

Further, the substrate with a film of the present invention is used for various applications for which it is required to impart design property.

Such applications include, for example, transparent glass and transparent plastic members to be used for a building member such as a window to be used for an exterior of a house or a building, a mirror, an advertising display, a bulletin board, a screen, a decorative building material for bath room, an aquarium, a member for a transport to be used for an automobile or an aircraft, a member to be used for art, sports, games, kitchen ware such as tableware such as a cup, a bottle or a plate or a beverage bottle, a laboratory instrument such as a beaker, a graduated cylinder or a hygrometer, or an exterior member (excluding a display part) of an apparatus such as a mobile phone (for example a smartphone), a personal digital assistant, a gaming machine or a remote controller.

In a case where the substrate with a film of the present invention is used as the above member, an article comprising the member may have a plurality of the substrates with a film of the present invention. Further, the article comprising the member may have, in addition to the substrate with a film of the present invention, a substrate having a rate covered with the fluorinated ether compound of higher than 80 and at most 100% (preferably 100%). In such a case, the preferred range and examples of the fluorinated ether compound are the same as those of the fluorinated ether compound used for the substrate with a film of the present invention. However, for an application which requires design property, a preferred optimum value of the rate covered is not particularly limited.

This application is a continuation of PCT Application No. PCT/JP2019/010666, filed on Mar. 14, 2019, which is based upon and claims the benefit of priorities from Japanese Patent Application No.2018-050077 filed on Mar. 16, 2018 and Japanese Patent Application No. 2018-181620 filed on Sep. 27, 2018. The contents of those applications are incorporated herein by reference in their entireties.

### REFERENCE SYMBOLS

10, 20, 30, 40, 50: substrate with a film

12, 22, 32, 42, 52: substrate

12a, 22a, 32a: first region

12b, 22b, 32b: second region

12X, 12Y: plane

14, 24, 34, 44, 54: first film

42a: center region (first region)

42b: peripheral region (second region)

52a: continuous region (first region)

52b: dispersed region (second region)

t: thickness direction

What is claimed is:

1. A substrate with a film, comprising a substrate and a film having a poly(oxyfluoroalkylene) chain disposed only on a part of region on the principal plane of the substrate.

2. The substrate with a film according to claim 1, wherein the film is a film formed by using a fluorinated ether compound having a poly(oxyfluoroalkylene) chain and a reactive silyl group.

3. The substrate with a film according to claim 1, wherein the area ratio of a first region on which the film having a poly(oxyfluoroalkylene) chain is disposed to a second region on which the film having a poly(oxyfluoroalkylene) chain is not disposed (area of the first region/area of the second region) is from 0.3 to 50.0.

4. The substrate with a film according to claim 1, wherein the substrate is a substrate for a touch panel or a display substrate.

5. The substrate with a film according to claim 1, wherein the substrate is composed of glass, and the rate of the principal plane covered with the film having a poly(oxyfluoroalkylene) chain is from 20 to 97%.

6. The substrate with a film according to claim 1, wherein the film is disposed on a plurality of regions in dots.

7. The substrate with a film according to claim 6, wherein the plurality of regions in dots are arranged in a checkered flag form.

8. The substrate with a film according to claim 1, wherein the film is disposed on a strip region on the principal plane of the substrate.

9. The substrate with a film according to claim 1, wherein the substrate has on its principal plane a peripheral region and a center region surrounded by the peripheral region, and the film is disposed on the center region.

10. The substrate with a film according to claim 1, wherein the substrate has on its principal plane a plurality of dotted dispersed regions and a continuous region other than the dispersed regions, and the film is disposed on the continuous region.
